(19) United States
(12) Patent Application Publication
(10) Pub. No.: US 2013/0250875 A1
(43) Pub. Date: Sep. 26, 2013

(54) METHODS AND APPARATUS FOR UPLINK POWER CONTROL

(71) Applicant: QUALCOMM INCORPORATED, San Diego, CA (US)

(72) Inventors: Wanshi Chen, San Diego, CA (US); Peter Gaal, San Diego, CA (US); Hao Xu, San Diego, CA (US)

(73) Assignee: QUALCOMM INCORPORATED, San Diego, CA (US)

(21) Appl. No.: 13/793,587

(22) Filed: Mar. 11, 2013

Related U.S. Application Data
(60) Provisional application No. 61/615,036, filed on Mar. 23, 2012.

(51) Int. Cl. H04W 52/36

(52) U.S. Cl. CPC H04W 52/365
USPC 370/329

(57) ABSTRACT

Certain aspects of the present disclosure relate to methods and apparatus for uplink power control when at least two separate power control algorithms are utilized for adjusting transmission power of uplink transmissions on one or more uplink channels to one or more access points. The method includes transmitting one or more power headroom report (PHR) based on channel and/or system parameters. In addition, methods are presented to match power control for uplink channels when different power control algorithms are used for those uplink channels. Furthermore, methods are proposed to compensate for a switch between reference signals on which the power control algorithms are based.

### CLAIM OF PRIORITY UNDER 35 U.S.C. §119

The present Application for Patent claims priority to U.S. Provisional Application No. 61/615,036, entitled, “Techniques for Uplink Power Control in Coordinated Multipoint Systems,” filed Mar. 23, 2012, and assigned to the assignee hereof, which is hereby expressly incorporated by reference herein.

### TECHNICAL FIELD

Certain aspects of the disclosure generally relate to wireless communications and, more particularly, to techniques for power control for coordinated multi-point (CoMP) transmission and reception in heterogeneous networks (HetNet).

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks and Single-Carrier FDMA (SC-FDMA) networks.

A wireless communication network may include a number of base stations (BS) that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

In an aspect of the disclosure, methods, corresponding apparatus and program products, for wireless communications are provided.

Certain aspects of the present disclosure provide a method for wireless communications by a user equipment (UE). The method generally includes utilizing at least two separate power control algorithms for adjusting transmission power of uplink transmissions on a same uplink channel to at least one access point, and transmitting a single power headroom report (PHR) regardless of the number of separate power control algorithms utilized, the single PHR generated based on a comparison of a current uplink transmit power to a threshold value.

Certain aspects of the present disclosure provide a method for wireless communications by an access point. The method generally includes receiving uplink transmission from a user equipment (UE) utilizing at least two separate power control algorithms for adjusting transmission power on a same uplink channel to the access point and receiving a single power headroom report (PHR) regardless of the number of separate power control algorithms utilized, the single PHR generated based on a comparison of a current uplink transmit power to a threshold value.

Certain aspects of the present disclosure provide a method for wireless communications by a user equipment (UE). The method generally includes utilizing at least two separate power control algorithms for adjusting transmission power of uplink transmissions on a same uplink channel to at least one access point, and transmitting at least two power headroom reports (PHRs), each PHR generated based on a comparison of a current uplink transmit power to a threshold value.

Certain aspects of the present disclosure provide a method for wireless communications by an access point. The method generally includes receiving uplink transmission from a user equipment (UE) utilizing at least two separate power control algorithms for adjusting transmission power on a same uplink channel to the access point, and receiving at least two power headroom reports (PHRs), each PHR generated based on a comparison of a current uplink transmit power to a threshold value.

Certain aspects of the present disclosure provide a method for wireless communications by a user equipment (UE). The method generally includes utilizing at least two separate power control algorithms for adjusting transmission power of uplink transmissions on at least one uplink channel to at least one access point, and taking action to match power control for uplink channels when different power control algorithms are used for those uplink channels.

Certain aspects of the present disclosure provide a method for wireless communications by a user equipment (UE). The method generally includes utilizing at least one power control algorithm for adjusting transmission power of uplink transmissions on at least one uplink channel to at least one access point and taking action to compensate for a switch between reference signals (RSs) on which the at least one power control algorithm is based.

Certain aspects of the present disclosure provide an apparatus for wireless communications by a user equipment (UE). The apparatus generally includes means for utilizing at least two separate power control algorithms for adjusting transmission power of uplink transmissions on a same uplink channel to at least one access point, and means for transmitting a single power headroom report (PHR) regardless of the number of separate power control algorithms utilized, the single PHR generated based on a comparison of a current uplink transmit power to a threshold value.

Certain aspects of the present disclosure provide an apparatus for wireless communications by an access point. The apparatus generally includes means for receiving uplink transmission from a user equipment (UE) utilizing at least two separate power control algorithms for adjusting transmission power on a same uplink channel to the access point, and means for receiving a single power headroom report (PHR) regardless of the number of separate power control algorithms utilized, the single PHR generated based on a comparison of a current uplink transmit power to a threshold value.

Certain aspects of the present disclosure provide an apparatus for wireless communications by a user equipment (UE). The apparatus generally includes means for utilizing at least two separate power control algorithms for adjusting transmission power of uplink transmissions on a same uplink channel to at least one access point, and means for transmitting at least two power headroom reports (PHRs), each PHR generated based on a comparison of a current uplink transmit power to a threshold value.

Certain aspects of the present disclosure provide an apparatus for wireless communications by an access point. The apparatus generally includes means for receiving uplink transmission from a user equipment (UE) utilizing at least two separate power control algorithms for adjusting transmission power on a same uplink channel to the access point, and means for receiving at least two power headroom reports (PHRs), each PHR generated based on a comparison of a current uplink transmit power to a threshold value.

Certain aspects of the present disclosure provide an apparatus for wireless communications by a user equipment (UE). The apparatus generally includes means for utilizing at least two separate power control algorithms for adjusting transmission power of uplink transmissions on at least one uplink channel to at least one access point, and means for taking action to match power control for uplink channels when different power control algorithms are used for those uplink channels.

Certain aspects of the present disclosure provide an apparatus for wireless communications by a user equipment (UE). The apparatus generally includes means for utilizing at least one power control algorithm for adjusting transmission power of uplink transmissions on at least one uplink channel to at least one access point, and means for taking action to compensate for a switch between reference signals (RSs) on which the at least one power control algorithm is based.

Certain aspects of the present disclosure provide an apparatus for wireless communications by a user equipment (UE). The apparatus generally includes at least one processor and a memory coupled to the at least one processor. The at least one processor is configured to utilize at least two separate power control algorithms for adjusting transmission power of uplink transmissions on a same uplink channel to at least one access point, and transmit a single power headroom report (PHR) regardless of the number of separate power control algorithms utilized, the single PHR generated based on a comparison of a current uplink transmit power to a threshold value.

Certain aspects of the present disclosure provide an apparatus for wireless communications by an access point. The apparatus generally includes at least one processor and a memory coupled to the at least one processor. The at least one processor is configured to receive uplink transmission from a user equipment (UE) utilizing at least two separate power control algorithms for adjusting transmission power on a same uplink channel to the access point, and receive a single power headroom report (PHR) regardless of the number of separate power control algorithms utilized, the single PHR generated based on a comparison of a current uplink transmit power to a threshold value.

Certain aspects of the present disclosure provide an apparatus for wireless communications by a user equipment (UE). The apparatus generally includes at least one processor and a memory coupled to the at least one processor. The at least one processor is configured to utilize at least two separate power control algorithms for adjusting transmission power of uplink transmissions on a same uplink channel to at least one access point, and transmit at least two power headroom reports (PHRs), each PHR generated based on a comparison of a current uplink transmit power to a threshold value.

Certain aspects of the present disclosure provide an apparatus for wireless communications by an access point. The apparatus generally includes at least one processor and a memory coupled to the at least one processor. The at least one processor is configured to receive uplink transmission from a user equipment (UE) utilizing at least two separate power control algorithms for adjusting transmission power on a same uplink channel to the access point, and receive at least two power headroom reports (PHRs), each PHR generated based on a comparison of a current uplink transmit power to a threshold value.

Certain aspects of the present disclosure provide an apparatus for wireless communications by a user equipment (UE). The apparatus generally includes at least one processor and a memory coupled to the at least one processor. The at least one processor is configured to utilize at least two separate power control algorithms for adjusting transmission power of uplink transmissions on at least one uplink channel to at least one access point, and take action to match power control for uplink channels when different power control algorithms are used for those uplink channels.

Certain aspects of the present disclosure provide an apparatus for wireless communications by a user equipment (UE). The apparatus generally includes at least one processor and a memory coupled to the at least one processor. The at least one processor is configured to utilize at least one power control algorithm for adjusting transmission power of uplink transmissions on at least one uplink channel to at least one access point, and take action to compensate for a switch between reference signals (RSs) on which the at least one power control algorithm is based.

Certain aspects provide computer-program product for wireless communications by a UE, the computer-program product comprising a non-transitory computer readable storage medium with computer-readable instructions stored thereon the instructions being executable by one or more processors. The computer-readable instructions operable for causing a processor to utilize at least two separate power control algorithms for adjusting transmission power of uplink transmissions on a same uplink channel to at least one access point and transmit a single power headroom report (PHR) regardless of the number of separate power control algorithms utilized, the single PHR generated based on a comparison of a current uplink transmit power to a threshold value.

Certain aspects provide computer-program product for wireless communications by an access point, the computer-program product comprising a non-transitory computer readable storage medium with computer-readable instructions stored thereon the instructions being executable by one or more processors. The computer-readable instructions operable for causing a processor to receive uplink transmission from a user equipment (UE) utilizing at least two separate power control algorithms for adjusting transmission power on a same uplink channel to the access point, and receive a single power headroom report (PHR) regardless of the number of separate power control algorithms utilized, the single PHR generated based on a comparison of a current uplink transmit power to a threshold value.

Certain aspects provide computer-program product for wireless communications by a UE, the computer-program product comprising a non-transitory computer readable storage medium with computer-readable instructions stored thereon the instructions being executable by one or more processors. The computer-readable instructions operable for causing a processor to utilize at least two separate power control algorithms for adjusting transmission power of uplink transmissions on a same uplink channel to at least one access point, and transmit at least two power headroom reports (PHRs), each PHR generated based on a comparison of a current uplink transmit power to a threshold value.

Certain aspects provide computer-program product for wireless communications by a UE, the computer-program product comprising a non-transitory computer readable storage medium with computer-readable instructions stored thereon the instructions being executable by one or more processors. The computer-readable instructions operable for causing a processor to receive uplink transmission from a user equipment (UE) utilizing at least two separate power control algorithms for adjusting transmission power on a same uplink channel to the access point, and receive at least two power headroom reports (PHRs), each PHR generated based on a comparison of a current uplink transmit power to a threshold value.

Certain aspects provide computer-program product for wireless communications by a UE, the computer-program product comprising a non-transitory computer readable storage medium with computer-readable instructions stored thereon the instructions being executable by one or more processors. The computer-readable instructions operable for causing a processor to utilize at least two separate power control algorithms for adjusting transmission power of uplink transmissions on at least one uplink channel to at least one access point, and take action to match power control for uplink channels when different power control algorithms are used for those uplink channels.

Certain aspects provide computer-program product for wireless communications by a UE, the computer-program product comprising a non-transitory computer readable storage medium with computer-readable instructions stored thereon the instructions being executable by one or more processors. The computer-readable instructions operable for causing a processor to utilize at least one power control algorithm for adjusting transmission power of uplink transmissions on at least one uplink channel to at least one access point, and take action to compensate for a switch between reference signals (RSs) on which the at least one power control algorithm is based.

Various aspects and features of the disclosure are described in further detail below.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network in accordance with certain aspects of the present disclosure.

FIG. 2A shows an example format for the uplink in Long Term Evolution (LTE) in accordance with certain aspects of the present disclosure.

FIG. 3 shows a block diagram conceptually illustrating an example of a Node B in communication with a user equipment device (UE) in a wireless communications network in accordance with certain aspects of the present disclosure.

FIG. 4 illustrates an example heterogeneous network (HetNet) in accordance with certain aspects of the present disclosure.

FIG. 5 illustrates example resource partitioning in a heterogeneous network in accordance with certain aspects of the present disclosure.

FIG. 6 illustrates example cooperative partitioning of subframes in a heterogeneous network in accordance with certain aspects of the present disclosure.

FIG. 7 is a diagram illustrating a range expanded cellular region in a heterogeneous network.

FIG. 8 is a diagram illustrating a network with a macro eNB and remote radio heads (RRHs) in accordance with certain aspects of the present disclosure.

FIG. 9 illustrates an example scenario for HetNet CoMP where only the macro cell transmits a common reference signal (CRS) in accordance with certain aspects of the present disclosure.

FIG. 10 illustrates example operations for uplink power control that may be performed by a user equipment, in accordance with certain aspects of the disclosure.

FIG. 11 illustrates example operations for power control, performed at a base station, in accordance with certain aspects of the disclosure.

FIG. 12 illustrates example operations for uplink power control that may be performed by a user equipment, in accordance with certain aspects of the disclosure.

FIG. 13 illustrates example operations for power control, performed at a base station, in accordance with certain aspects of the disclosure.

FIG. 14 illustrates example operations for uplink power control that may be performed by a user equipment, in accordance with certain aspects of the disclosure.

FIG. 15 illustrates example operations for uplink power control, performed at a user equipment, in accordance with certain aspects of the disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

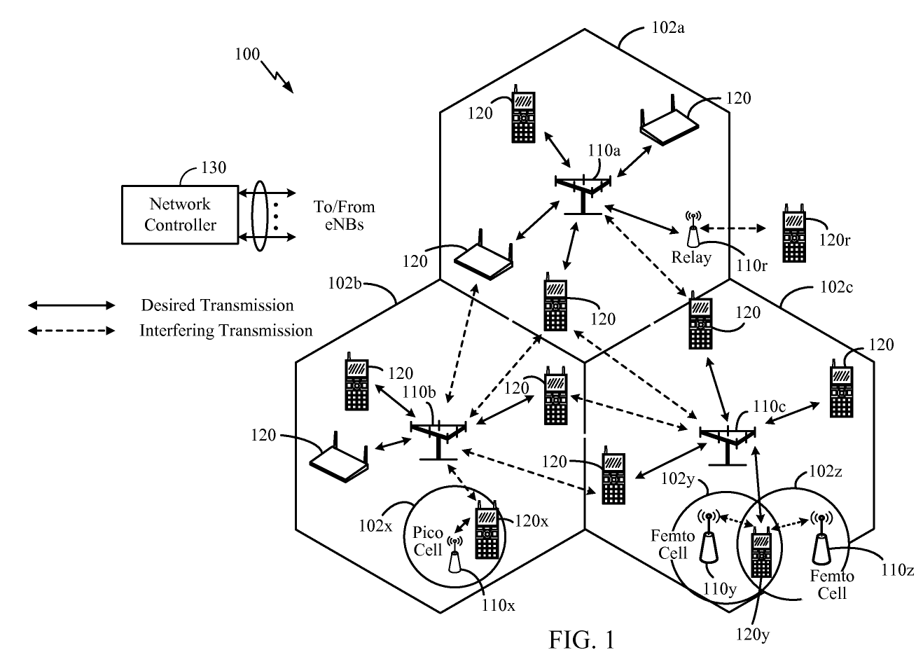

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB (i.e., a macro base station). An eNB for a pico cell may be referred to as a pico eNB (i.e., a pico base station). An eNB for a femto cell may be referred to as a femto eNB (i.e., a femto base station) or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB. For certain aspects, the UE may comprise an LTE Release 10 UE.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

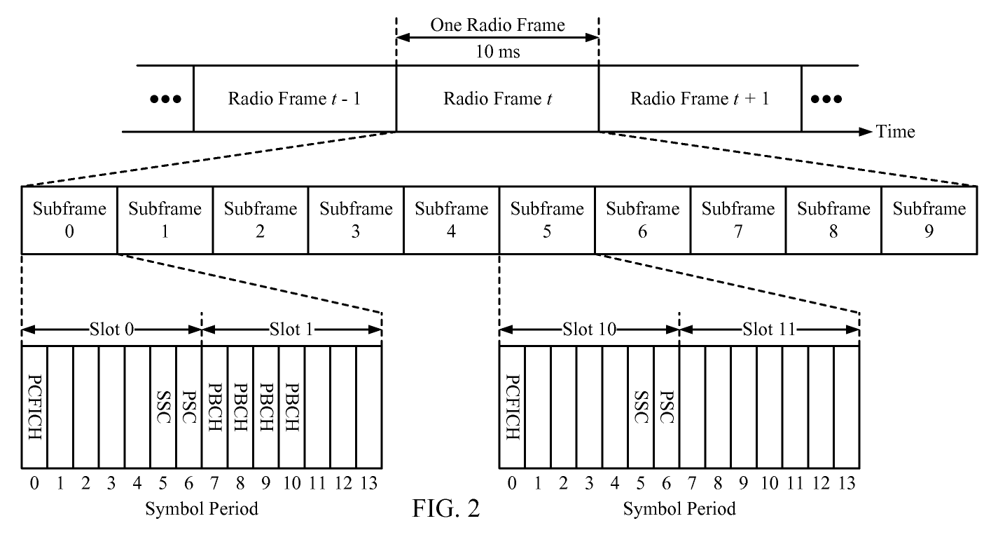

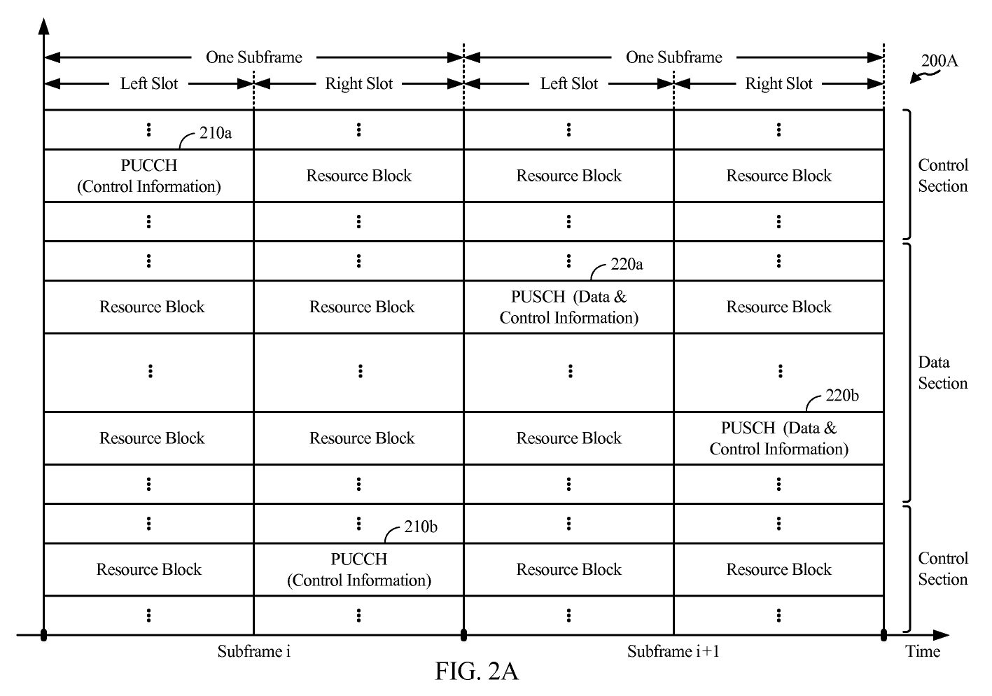

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2A.

A UE may be within the coverage of multiple eNBs. One of these eNBs may be selected to serve the UE. The serving eNB may be selected based on various criteria such as received power, path-loss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower pathloss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the pathloss for eNB 110x is lower than the pathloss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of signals from the eNB received at a UE (and not based on the transmit power level of the eNB).

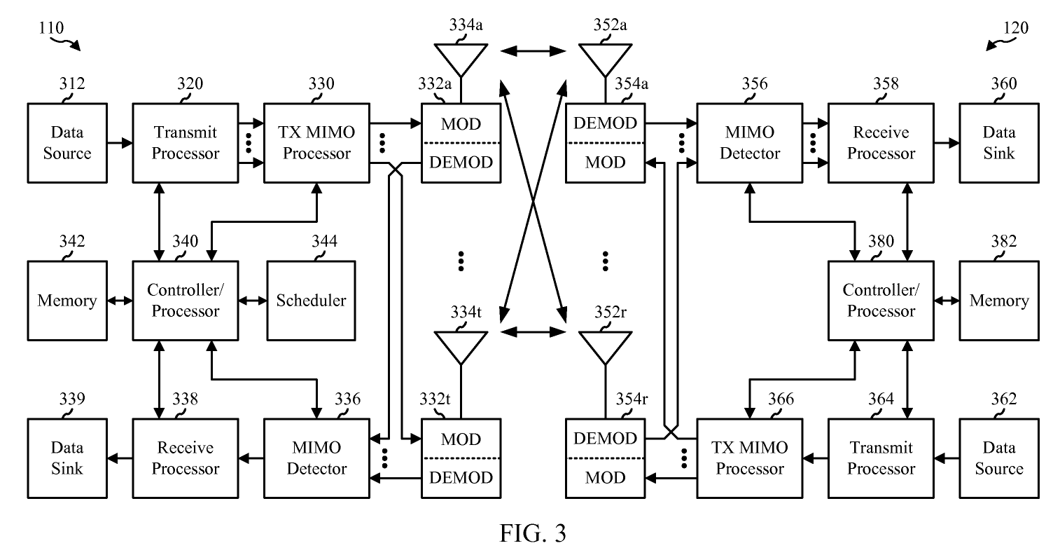

FIG. 3 is a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and the UE 120 may be UE 120y. The eNB 110 may also be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

The controllers/processors 340 and 380 may direct the operation at the eNB 110 and the UE 120, respectively. The controller/processor 340, receive processor 338, and/or other processors and modules at the eNB 110 may perform or direct operations and/or processes for the techniques described herein. The memories 342 and 382 may store data and program codes for the eNB 110 and the UE 120, respectively. A scheduler 344 may schedule UEs for data transmission on the downlink and/or uplink.

### Example Resource Partitioning

According to certain aspects of the present disclosure, when a network supports enhanced inter-cell interference coordination (eICIC), the base stations may negotiate with each other to coordinate resources in order to reduce or eliminate interference by the interfering cell giving up part of its resources. In accordance with this interference coordination, a UE may be able to access a serving cell even with severe interference by using resources yielded by the interfering cell.

For example, a femto cell with a closed access mode (i.e., in which only a member femto UE can access the cell) in the coverage area of an open macro cell may be able to create a “coverage hole” (in the femto cell's coverage area) for a macro cell by yielding resources and effectively removing interference. By negotiating for a femto cell to yield resources, the macro UE under the femto cell coverage area may still be able to access the UE's serving macro cell using these yielded resources.

In a radio access system using OFDM, such as Evolved Universal Terrestrial Radio Access Network (E-UTRAN), the yielded resources may be time based, frequency based, or a combination of both. When the coordinated resource partitioning is time based, the interfering cell may simply not use some of the subframes in the time domain. When the coordinated resource partitioning is frequency based, the interfering cell may yield subcarriers in the frequency domain. With a combination of both frequency and time, the interfering cell may yield frequency and time resources.

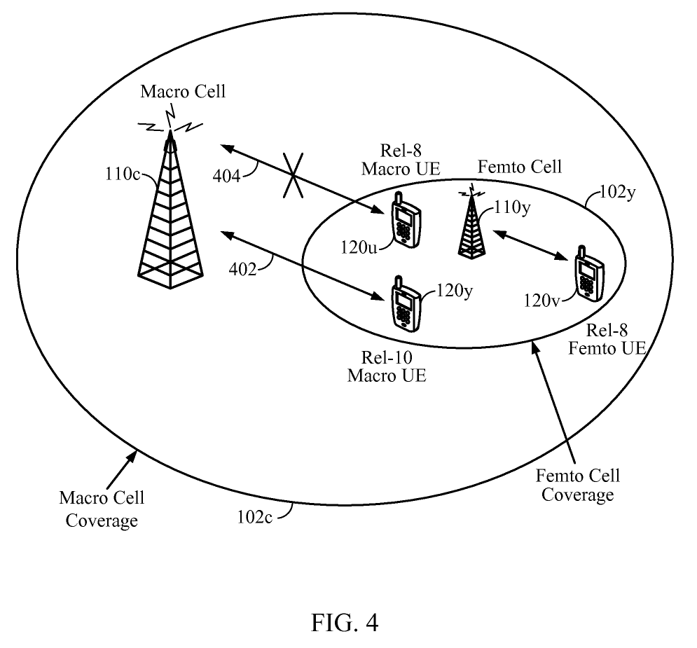

FIG. 4 illustrates an example scenario where eICIC may allow a macro UE 120y supporting eICIC (e.g., a Rel-10 macro UE as shown in FIG. 4) to access the macro cell 110c even when the macro UE 120y is experiencing severe interference from the femto cell y, as illustrated by the solid radio link 402. A legacy macro UE 120u (e.g., a Rel-8 macro UE as shown in FIG. 4) may not be able to access the macro cell 110c under severe interference from the femto eNB 110y, as illustrated by the broken radio link 404. A femto UE 120v (e.g., a Rel-8 femto UE as shown in FIG. 4) may access the femto cell 110y without any interference problems from the macro cell 110c.

According to certain aspects, networks may support eICIC, where there may be different sets of partitioning information. A first of these sets may be referred to as Semi-static Resource Partitioning Information (SRPI). A second of these sets may be referred to as Adaptive Resource Partitioning Information (ARPI). As the name implies, SRPI typically does not change frequently, and SRPI may be sent to a UE so that the UE can use the resource partitioning information for the UE's own operations.

As an example, the resource partitioning may be implemented with 8 ms periodicity (8 subframes) or 40 ms periodicity (40 subframes). According to certain aspects, it may be assumed that frequency division duplexing (FDD) may also be applied such that frequency resources may also be partitioned. For communications via the downlink (e.g., from a cell node B to a UE), a partitioning pattern may be mapped to a known subframe (e.g., a first subframe of each radio frame that has a system frame number (SFN) value that is a multiple of an integer N, such as 4). Such a mapping may be applied in order to determine resource partitioning information (RPI) for a specific subframe. As an example, a subframe that is subject to coordinated resource partitioning (e.g., yielded by an interfering cell) for the downlink may be identified by an index:

Index_{SRPI}_{_{—}}_{DL}=(SFN*10+subframe number)mod8

For the uplink, the SRPI mapping may be shifted, for example, by 4 ms. Thus, an example for the uplink may be:

Index_{SRPI}_{_{—}}_{UL}=(SFN*10+subframe number+4)mod8

SRPI may use the following three values for each entry:

U (Use): this value indicates the subframe has been cleaned up from the dominant interference to be used by this cell (i.e., the main interfering cells do not use this subframe);

N (No Use): this value indicates the subframe shall not be used; and

X (Unknown): this value indicates the subframe is not statically partitioned. Details of resource usage negotiation between base stations are not known to the UE.

Another possible set of parameters for SRPI may be the following:

U (Use): this value indicates the subframe has been cleaned up from the dominant interference to be used by this cell (i.e., the main interfering cells do not use this subframe);

N (No Use): this value indicates the subframe shall not be used;

X (Unknown): this value indicates the subframe is not statically partitioned (and details of resource usage negotiation between base stations are not known to the UE); and

C (Common): this value may indicate all cells may use this subframe without resource partitioning. This subframe may be subject to interference, so that the base station may choose to use this subframe only for a UE that is not experiencing severe interference.

The serving cell's SRPI may be broadcasted over the air. In E-UTRAN, the SRPI of the serving cell may be sent in a master information block (MIB), or one of the system information blocks (SIBs). A predefined SRPI may be defined based on the characteristics of cells, e.g. macro cell, pico cell (with open access), and femto cell (with closed access). In such a case, encoding of SRPI in the system overhead message may result in more efficient broadcasting over the air.

The base station may also broadcast the neighbor cell's SRPI in one of the SIBs. For this, SRPI may be sent with its corresponding range of physical cell identifiers (PCIs).

ARPI may represent further resource partitioning information with the detailed information for the ‘X’ subframes in SRPI. As noted above, detailed information for the ‘X’ subframes is typically only known to the base stations, and a UE does not know it.

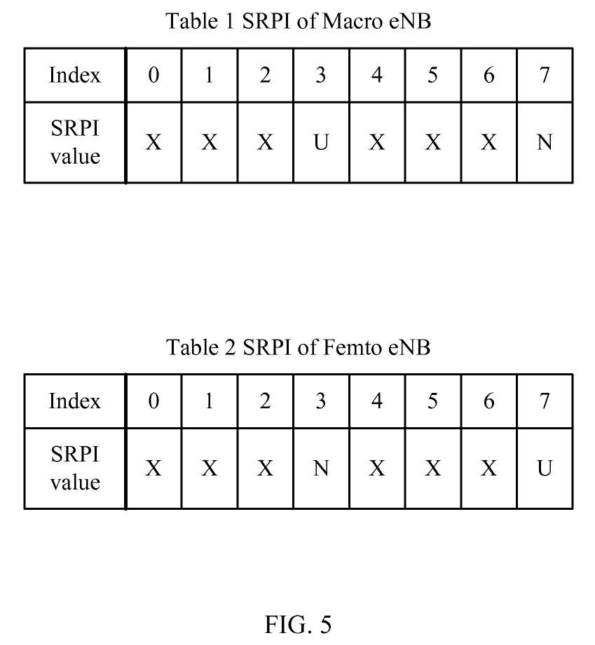

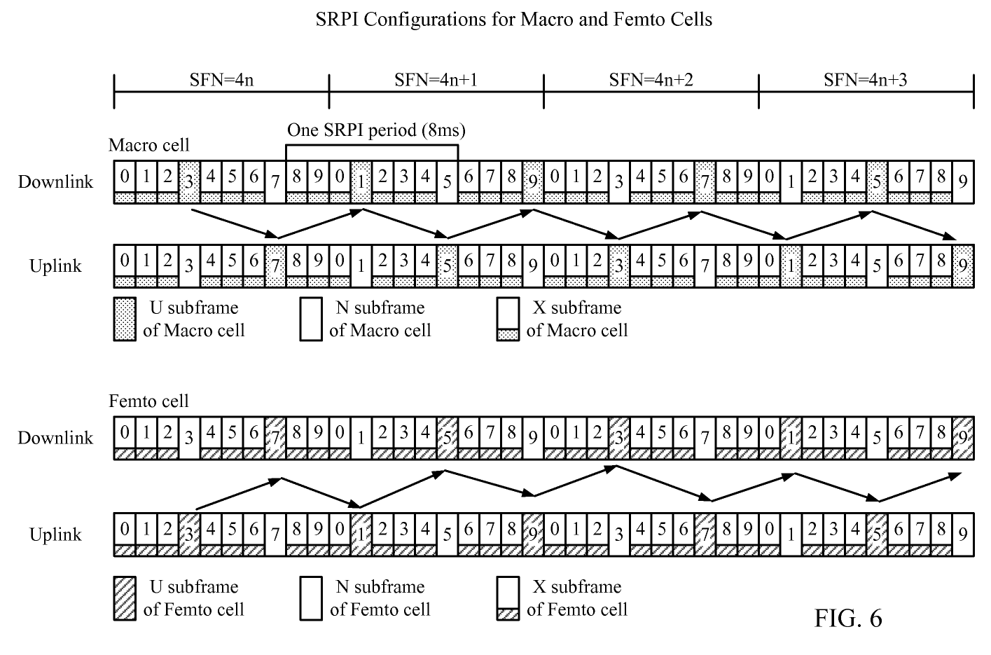

FIGS. 5 and 6 illustrate examples of SRPI assignment in the scenario with macro and femto cells. A U, N, X, or C subframe is a subframe corresponding to a U, N, X, or C SRPI assignment.

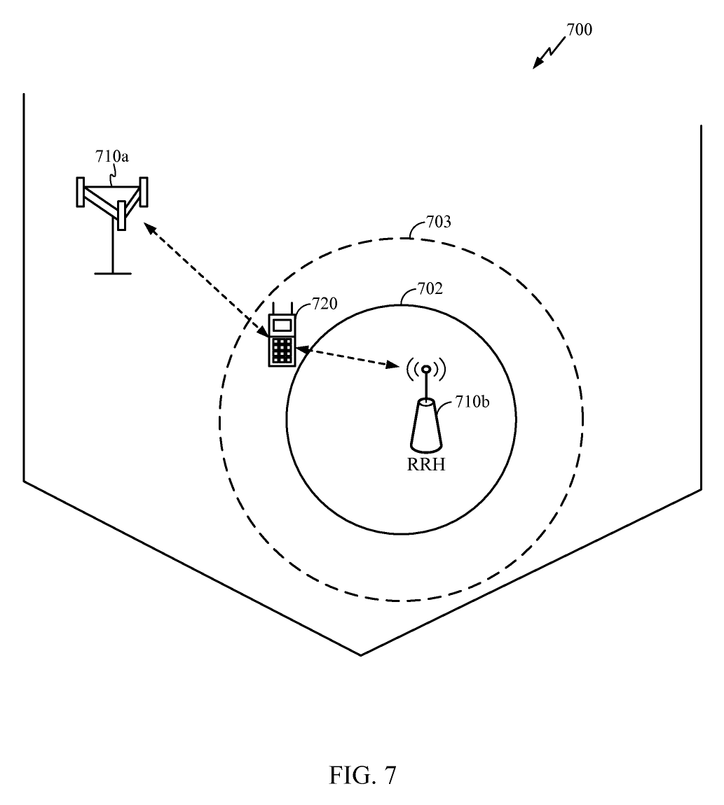

FIG. 7 is a diagram 700 illustrating a range expanded cellular region in a heterogeneous network. A lower power class eNB such as the RRH 710b may have a range expanded cellular region 703 that is expanded from the cellular region 702 through enhanced inter-cell interference coordination between the RRH 710b and the macro eNB 710a and through interference cancelation performed by the UE 720. In enhanced inter-cell interference coordination, the RRH 710b receives information from the macro eNB 710a regarding an interference condition of the UE 720. The information allows the RRH 710b to serve the UE 720 in the range expanded cellular region 703 and to accept a handoff of the UE 720 from the macro eNB 710a as the UE 720 enters the range expanded cellular region 703.

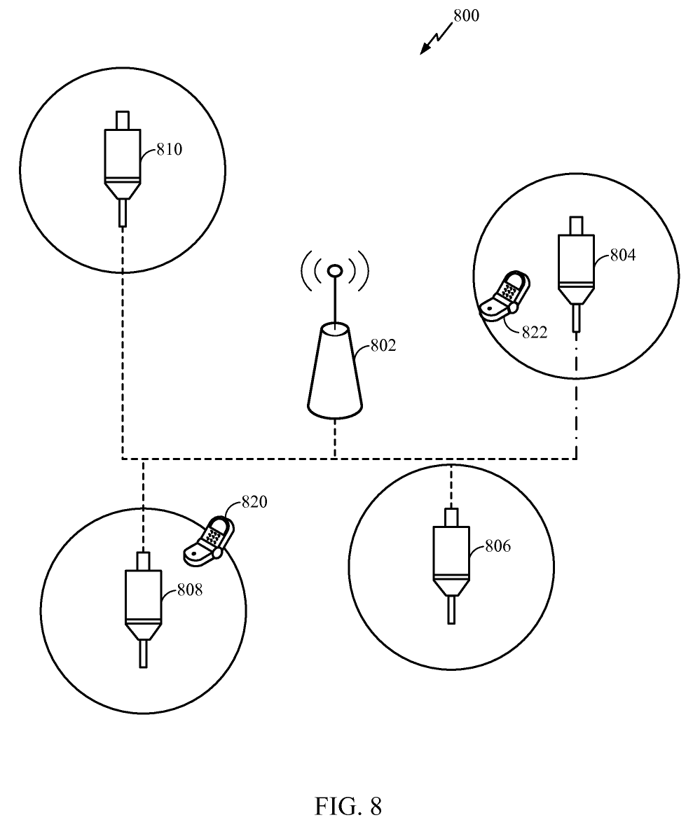

FIG. 8 is a diagram illustrating a network 800, which includes a macro node and a number of remote radio heads (RRHs) in accordance with certain aspects of the present disclosure. The macro node 802 is connected to RRHs 804, 806, 808, 810 with optical fiber. In certain aspects, network 800 may be a homogeneous network or a heterogeneous network and the RRHs 804-810 may be low power or high power RRHs. In an aspect, the macro node 802 handles all scheduling within the cell, for itself and the RRHs. The RRHs may be configured with the same cell identifier (ID) as the macro node 802 or with different cell IDs. If the RRHs are configured with the same cell ID, the macro node 802 and the RRHs may operate as essentially one cell controlled by the macro node 802. On the other hand, if the RRHs and the macro node 802 are configured with different cell IDs, the macro node 802 and the RRHs may appear to a UE as different cells, though all control and scheduling may still remain with the macro node 802. It should further be appreciated that the processing for the macro node 802 and the RRHs 804, 806, 808, 810 may not necessarily have to reside at the macro node. It may also be performed in a centralized fashion at some other network device or entity that is connected with the macro and the RRHs.

As used herein, the term transmission/reception point (“TxP”) generally refers geographically separated transmission/reception nodes controlled by at least one central entity (e.g., eNodeB), which may have the same or different cell IDs.

In certain aspects, when each of the RRHs share the same cell ID with the macro node 802, control information may be transmitted using CRS from the macro node 802 or both the macro node 802 and all of the RRHs. The CRS is typically transmitted from each of the transmission points using the same resource elements, and therefore the signals collide. When each of the transmission points has the same cell ID, CRS transmitted from each of the transmission points may not be differentiated. In certain aspects, when the RRHs have different cell IDs, the CRS transmitted from each of the TxPs using the same resource elements may or may not collide. Even in the case, when the RRHs have different cell IDs and the CRS collide, advanced UEs may differentiate CRS transmitted from each of the TxPs using interference cancellation techniques and advanced receiver processing.

In certain aspects, when all transmission points are configured with the same cell ID and CRS is transmitted from all transmission points, proper antenna virtualization is needed if there are an unequal number of physical antennas at the transmitting macro node and/or RRHs. That is, CRS is to be transmitted with an equal number of CRS antenna ports. For example, if the macro node 802 and the RRHs 804, 806, 808 each have four physical antennas and the RRH 810 has two physical antennas, a first antenna of the RRH 810 may be configured to transmit using two CRS ports and a second antenna of the RRH 810 may be configured to transmit using a different two CRS ports. Alternatively, for the same deployment, macro node 802 and RRHs 804, 806, 808, may transmit only two CRS antenna ports from selected two out of the four transmit antennas per transmission point. Based on these examples, it should be appreciated that the number of antenna ports may be increased or decreased in relation to the number of physical antennas.

As discussed supra, when all transmission points are configured with the same cell ID, the macro node 802 and the RRHs 804-810 may all transmit CRS. However, if only the macro node 802 transmits CRS, outage may occur close to an RRH due to automatic gain control (AGC) issues. In such a scenario, CRS based transmission from the macro 802 may be received at low receive power while other transmissions originating from the close-by RRH may be received at much larger power. This power imbalance may lead to the aforementioned AGC issues.

In summary, typically, a difference between same/different cell ID setups relates to control and legacy issues and other potential operations relying on CRS. The scenario with different cell IDs, but colliding CRS configuration may have similarities with the same cell ID setup, which by definition has colliding CRS. The scenario with different cell IDs and colliding CRS typically has the advantage compared to the same cell ID case that system characteristics/components which depend on the cell ID (e.g., scrambling sequences, etc.) may be more easily differentiated.

The exemplary configurations are applicable to macro/RRH setups with same or different cell IDs. In the case of different cell IDs, CRS may be configured to be colliding, which may lead to a similar scenario as the same cell ID case but has the advantage that system characteristics which depend on the cell ID (e.g., scrambling sequences, etc.) may be more easily differentiated by the UE).

In certain aspects, an exemplary macro/RRH entity may provide for separation of control/data transmissions within the transmission points of this macro/RRH setup. When the cell ID is the same for each transmission point, the PDCCH may be transmitted with CRS from the macro node 802 or both the macro node 802 and the RRHs 804-810, while the PDSCH may be transmitted with channel state information reference signal (CSI-RS) and demodulation reference signal (DM-RS) from a subset of the transmission points. When the cell ID is different for some of the transmission points, PDCCH may be transmitted with CRS in each cell ID group. The CRS transmitted from each cell ID group may or may not collide. UEs may not differentiate CRS transmitted from multiple transmission points with the same cell ID, but may differentiate CRS transmitted from multiple transmission points with different cell IDs (e.g., using interference cancellation or similar techniques).

In certain aspects, in the case where all transmission points are configured with the same cell ID, the separation of control/data transmissions enables a UE transparent way of associating UEs with at least one transmission point for data transmission while transmitting control based on CRS transmissions from all the transmission points. This enables cell splitting for data transmission across different transmission points while leaving the control channel common The term “association” above means the configuration of antenna ports for a specific UE for data transmission. This is different from the association that would be performed in the context of handover. Control may be transmitted based on CRS as discussed supra. Separating control and data may allow for a faster reconfiguration of the antenna ports that are used for a UE's data transmission compared to having to go through a handover process. In certain aspects, cross transmission point feedback may be possible by configuring a UE's antenna ports to correspond to the physical antennas of different transmission points.

In certain aspects, UE-specific reference signals enable this operation (e.g., in the context of LTE-A, Rel-10 and above). CSI-RS and DM-RS are the reference signals used in the LTE-A context. Interference estimation may be carried out based on or facilitated by CSI-RS muting. When control channels are common to all transmission points in the case of a same cell ID setup, there may be control capacity issues because PDCCH capacity may be limited. Control capacity may be enlarged by using FDM control channels. Relay PDCCH (R-PDCCH) or extensions thereof, such as an enhanced PDCCH (ePDCCH) may be used to supplement, augment, or replace the PDCCH control channel.

Power Control and User Multiplexing for CoMP

Various techniques have been considered for joint processing across heterogeneous networks coordinated multipoint (HetNet CoMP) eNBs. For example, within a macro cell coverage, multiple remote radio heads (RRHs) may be deployed to enhance capacity/coverage of a network. As discussed above, these RRHs may have a same cell ID as the macro cell, such that a single frequency network (SFN) is formed for downlink (DL) transmission. However, many issues may be encountered in the uplink (UL) for such a HetNet CoMP scheme. One problem may be that with a same physical cell identifier (PCI) for all cells, only one common reference signal power spectral density (CRS PSD) may be broadcasted. However, RRH and macro cell may have 16-20 dB power difference. This mismatch may lead to a large error in open loop power control (OL PC). Another problem may be that if only the macro cell transmits CRS, and no RRHs transmit CRS, a UE close to an RRH may transmit a very large UL signal to jam the reception for the RRH. These problems may lead to performance degradations.

The following disclosure discusses various ways to improve UL power control for different HetNet CoMP scenarios. In addition, various UL CoMP receiver and processing options, and UL channel configuration options are also discussed.

In certain aspects, various eNB power classes may be defined in HetNet CoMP. For example, macro cells with 46 dBm (nominal), pico cells with 30 dBm (nominal), or 23 and 37 dBm, RRH with 30 dBm (nominal) or 37 dBm possible, and Femto cells with 20 dBm (nominal).

A pico cell typically has its own physical cell identifier (PCI), may have X2 connection with a macro cell, may have own scheduler operation, and may link to multiple macro cells. An RRH may or may not have a same PCI as macro cell, may have fiber connection with the macro cell, and may have its scheduling performed only at the macro cell. A femto cell may have restricted association and is typically not considered for CoMP schemes.

### UL CoMP Processing

In certain aspects, various CoMP processing schemes may be defined when all cells or a subset of cells receive UL data, control and sounding reference signal (SRS).

In a first aspect, macro diversity reception may be defined for a subset of cells. For this aspect, whichever of the subset of cells successfully decodes the UL reception, may forward a decision to the serving cell.

In a second aspect, joint processing may be defined by combining log likelihood ratio (LLR) from a subset of cells. In this aspect, there may be a need to move LLRs to the serving cell.

In a third aspect, joint multi-user detection may be defined. This may include using different cyclic shifts/Walsh codes among users within a large macro/RRH region to separate users' channel(s). In an aspect, interference cancellation (IC) may be carried out for interfering users among all cells since all information is shared among all cells. In another aspect, data separation may be defined by spatial division multiple access SDMA, UL MU-MIMO etc.

In a fourth aspect, UL CoMP with Rel-11 UEs may be defined. In this aspect, MIMO/beamforming (BF) may be based on the SRS channel transmitted from multiple antennas. Further, precoding matrix selection may be chosen by the serving eNB based on SRS. Also, joint processing may be performed from multiple UL cells. In an aspect, code book design may be reused for UL since they are transmitter (Tx) driven.

### UL Power control

In certain aspects, for HetNet CoMP schemes where the macro cell and one or more RRHs share a same PCI, two scenarios may exist. In a first scenario, only the macro cell may transmit the CRS, PSS, SSS and/or PBCH. In an alternate scenario, both macro and RRHs may transmit the CRS, PSS, SSS and/or PBCH.

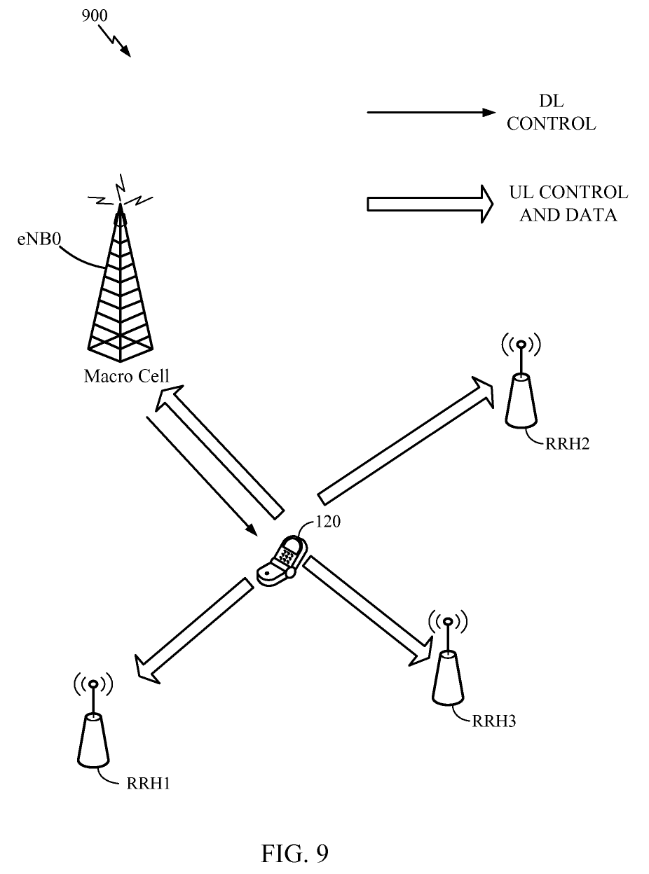

FIG. 9 illustrates an example scenario 900 for HetNet CoMP where only the macro cell transmits a common reference signal (CRS) in accordance with certain aspects of the present disclosure. The heterogeneous network of FIG. 9 includes eNBO associated with a macro cell and multiple RRHs that may be associated with pico cells including RRH1, RRH2 and RRH3. The RRHs 1, 2 and 3 may be connected with the eNBO via optical fiber cables. UE 120 may communicate with the eNBO as well as the RRHs 1, 2, and 3. eNB0 may transmit the CRS while the RRHs remain silent. In certain aspects, for DL, control may be based on the macro cell and data may be based on SFN from all cells (including macro and pico cells) or a subset of cells with UE-reference signals (RS) for downlink. On the other hand, for UL, both control and data may be received on multiple cells (e.g. enB0 as well as one or more RRHs).

In certain aspects, with DL CRS measurement from one cell (e.g. eNB 0) and UL reception from multiple cells (RRHs 1, 2 and 3), open loop power control (OL PC) may be inaccurate since DL pathloss (PL) may be measured at the UE 120 based on CRS from the macro cell (eNBO) only. In this scenario, OL PC may be accurate if UL is received by macro cell only.

Various power control options may be defined to address this problem. For example, in a first aspect, additional back off/reduction of transmit power from the UE 120 may be defined in OL PC algorithm to take into account the UL macro diversity gain or joint processing gain due to processing of UL signals by a plurality of transmission points. This additional reduction in transmit power of the UE may be signaled from eNB0 to the UE 120, for example to adjust P0 factor. In certain aspects, the P0 factor defines a target received power at the eNBO for a random access channel (RACH) that is set to a low value to allow low initial transmit power of the RACH. In an aspect, the P0 factor is determined and/or signaled to adjust the OL PC based on differences between pathloss between the UE and one or more transmission points involved in DL CoMP operations and one or more transmission points involved in UL CoMP operations. In an aspect, eNB may also signal one or more parameters that represents a pathloss difference between DL and UL serving nodes, which may be used by the UE in OL PC. In certain aspects, this method may be applicable to CoMP operations involving different DL transmission points and UL reception points.

In a second aspect, closed loop power control may be performed based on SRS transmitted from the UE 120. In an aspect, joint processing of the SRS may be carried out by the same cooperating cells as used for data. The closed loop PC may be based on the SRS channel signal to noise ratio (SNR) with an offset between PUSCH and SRS.

In a third aspect, a slow start random access channel RACH transmit power may be defined so that it will not jam the close-by cells.

### Example Methods for Uplink Power Control in Coordinated Multipoint Systems

Coordinated Multi-Point (CoMP) may include different schemes, such as coordinated scheduling/coordinated beamforming (CS/CB), dynamic point selection (DPS), and joint transmission (JT) both coherent or non-coherent. Various CoMP deployment scenarios may exist, including homogeneous CoMP across cells of the same macro site, homogeneous CoMP across three neighboring macro sites, heterogeneous CoMP across a macro cell and its piconets (e.g., remote radio heads-RRHs) in which a macro and the RRHs are configured with different cell IDs, and heterogeneous CoMP across a macro cell and its RRHs in which the macro cell and its RRHs are configured with similar cell IDs.

Generally, uplink power control may consist of both open loop and closed loop components and may involve various uplink channels, such as the physical uplink shared channel (PUSCH), physical uplink control channel (PUCCH), physical random access channel (PRACH) channels, and/or sounding reference signals (SRS).

In PUSCH power control, both accumulative and absolute power control modes may be supported. The power control mode of a UE may be configured via higher layers. For the accumulative power control mode, the accumulative power control commands may be represented by f(i), where i represents the subframe index, on a per carrier basis.

An accumulative power control mode may be supported for PUCCH. The accumulative power control commands may be represented by g(i), on a per carrier basis. SRS power control may use the same accumulative power control commands as used in PUSCH (e.g., f(i)) in addition to a configurable power offset with respect to PUSCH to account for bandwidth differences between the two channels.

Power Headroom Reports (PHRs) from the UE to the eNB helps the eNB understand the current power conditions at the UE. Accordingly, PHR may assist an eNB in making the appropriate UL scheduling decision. Moreover, PHR assists an eNB in learning whether the UE is power-limited or not. A PHR can be periodic or event driven, may be on a per carrier basis, and may be based on the current transmit power.

A UE may generate two different PHR types (e.g., type-1 and/or type-2). In a type-1 power headroom report, the UE may assume that there is only PUSCH transmission in a subframe. The UE may compare the PUSCH transmit power with a threshold (e.g., maximum power). Even if there is a PUCCH transmission on the same carrier, the PUCCH transmit power may not be included in the Type-1 power headroom report. If there is no actual PUSCH transmission, some reference PUSCH transmission may be used for type-1 PHR (e.g., one resource block (RB), no modulation and coding scheme (MCS) adjustment, and the like).

In a type-2 power headroom report, the UE may assume that both PUCCH and PUSCH have transmissions. The UE may compare the total power of the transmissions in the two channels with the maximum power threshold for PHR. If there is no actual PUCCH and/or PUSCH transmission, some reference PUCCH and/or PUSCH transmission may be used for these channels.

In order to initialize power on different channels, the UE may use different scenarios. For example, for the initial transmit power of PUSCH/SRS, upon reconfiguration of some open-loop power control parameters (e.g., P_O_UE_PUSCH), f(0) for a given carrier may be considered to be equal to zero. On the other hand, upon initial PUSCH transmission after PRACH, f(0) may be calculated as follows:

f(0)−Δᵣₐₘₚᵤₚ+δ^{msg2},

where δ_{msg2} may represent the Transmit Power Control (TPC) command indicated in the random access response, and Δᵣₐₘₚᵤₚ may be provided by higher layers and may correspond to the total power ramp-up from the first to the last preamble. In addition, upon deactivation of a secondary cell and re-activation of the secondary cell, f(i) may be maintained without change.

In order to initialize transmit power of PUCCH, if the open-loop power control parameter P_O_{'}UE_PUCCH is changed by higher layers, g(0) may be considered to be equal to zero. In addition, upon initial PUCCH transmission after PRACH, g(0) may be calculated as follows:

g(0)=Δᵣₐₘₚᵤₚ+δ_{msg2},

where δ_{msg2} may represent the TPC command indicated in the random access response and Δᵣₐₘₚᵤₚ may be provided by higher layers, which corresponds to the total power ramp-up from the first to the last preamble. Upon deactivation of a secondary cell and re-activation of the secondary cell, g(i) may be maintained without change.

For certain aspects, both DL CoMP and UL CoMP may benefit from power control enhancements. In some cases, such enhancements may include utilizing two or more sets of power control (e.g., separate algorithms) for at least some of the UL channels. The two or more sets may be in the form of open-loop power offset (e.g., configurable offset, different ways of pathloss estimation, and the like), different closed loop power functions (e.g., f₁(i) for one set, and f₂(i) for another set), or a combination thereof.

As an example, two sets of power control may be defined for PUSCH. This arrangement may be used, for example, when there is a possibility of dynamic point switching between two or more UL cells in serving the UL PUSCH transmissions for a UE. In another example, two sets of power control can be defined for SRS. One set may be used for DL CoMP operation (e.g., for CoMP set management, channel reciprocity based DL scheduling, and the like), and another set may be used for UL CoMP operation, such as rate adaptation, power control, CoMP management and the like. As yet another example, pathloss estimation for SRS may be based on CSI-RS, while pathloss estimation for PUSCH and PUCCH may be based on CRS, where pathloss estimation is used as one input to UL power control.

Certain aspects of the present disclosure provide solutions to deal with various issues that may arise when two or more sets of uplink power control are used for at least one of the UL channels. A first issue in this situation relates to PHR management. A second issue relates to ways to deal with mismatched power control. A mismatched power control may occur in several example situations. For example, mismatched power control may arise when different reference signals (RSs) are used for pathloss estimation for power control in different UL channels. For example, when channel state information reference signal (CSI-RS) is used for SRS power control, and CRS is used for PUSCH/PUCCH power control, a mismatch between power control schemes may arise.

As another example, when closed power control for PUSCH and closed power control for SRS are not bundled, mismatched power control may happen. In this example, the SRS may no longer be used for UL rate prediction. A third issue may relate to the fact that UL channels rely on CSI-RS for pathloss estimation for power control. In this situation, switching of CSI-RS should be addressed, as well as switching between CRS and CSI-RS. Details of each proposed solution will follow.

### Example PHR Handling

Typically, regardless of how many separate sets of uplink power control for an uplink control method are specified, one set may be active in a subframe. However, it is possible that two or more sets for the same uplink control are simultaneously active in a single subframe (e.g., parallel SRS transmissions in the same subframe, one for DL and the other for UL). The relationship among different sets for the same uplink control may generally be categorized as deterministic or nondeterministic.

In a deterministic relationship among different sets for the same uplink control, if the transmit power under a first power control set for the uplink control is known at the eNB, the eNB may be able to derive the transmit power under a second power control set for the same uplink control. For instance, the two sets may be specified as having two different power offsets, where the difference between the two power offsets is known at the eNB. As a result, the eNB may be able to figure out the transmit power under each set from the knowledge of the other set and the difference between the two power offsets. It is important to note that a deterministic property may be impacted by some factors, such as power saturation and the like.

In a nondeterministic relationship among different sets for the same uplink control, even if transmit power under a first power control set for the uplink control is known at the eNB, the eNB may not be able to derive the transmit power under a second power control set for the same uplink control. For instance, the two sets may be specified as having two different f(i) functions (e.g., f₁(i) and f₂(i)) which are updated based on the same or separate power control commands and/or are subject to errors over the air. The functions f₁(i) and f₂(i) may also be subject to other conditions (e.g., frozen upon power saturation, reset under certain conditions, and the like). As a result, the relationship between f₁(i) and f₂(i) may not be known at the eNB, and consequently, the relationship between the transmit power levels under the two power control sets for the same channel may not be known at the eNB.

The present disclosure provides design alternatives for dealing with the above-referenced issues related to PHR handling. For certain aspects, a single PHR may be transmitted regardless of the number of sets defined for an uplink channel and the number of uplink channels with two or more power control sets. The PHR may include type-1 and/or type-2 reports or any other report type. This scenario may be preferable when the relationship among different sets of the same uplink channel is deterministic such that from the PHR, the eNB can figure out the power conditions under all power control sets for the uplink channel.

The single PHR report may use one of the power control sets for PHR. As an example, consider two power control sets for PUSCH, and a single set for PUCCH. In this case, the PHR reporting may be based on the first power control set for PUSCH and/or the power control set for PUCCH. The first power control set for PUSCH and/or the power control set for PUCCH may be hardcoded in the device or signaled over the air.

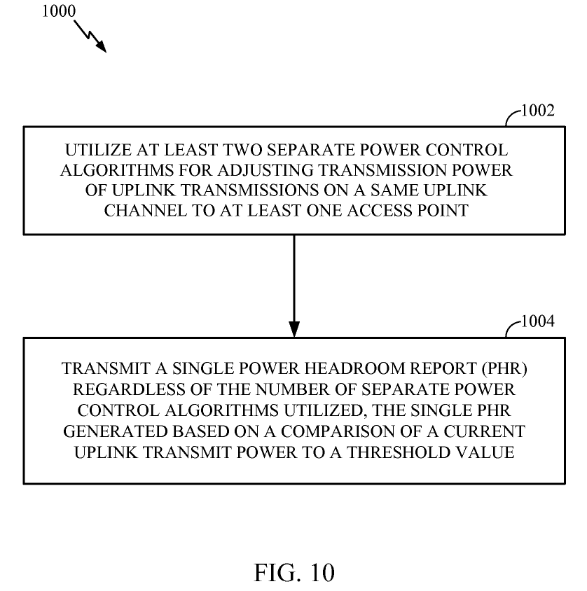

FIG. 10 illustrates example operations 1000 for uplink power control performed at a user equipment, in accordance with certain aspects of the disclosure. These operations may be executed, for example, at processor(s) shown in FIG. 3 of UE 120. More generally, these operations may be performed by any suitable components or other means capable of performing the corresponding functions.

At 1002, the UE may utilize at least two separate power control algorithms for adjusting transmission power of uplink transmissions on a same uplink channel to at least one access point. For certain aspects, the uplink channel to the at least one access point may be on a single component carrier. For example, the access point may be a part of a set of access points involved in coordinated multipoint (CoMP) operations with the UE. As an example, a macro cell and a pico cell may use the same component carrier for receiving PUSCH from a UE. For certain aspects, a relationship between the at least two separate power control algorithms may be deterministic, such that the eNB may determine power conditions corresponding to the at least two separate power control algorithms from the single PHR.

At 1004, the UE may transmit a single power headroom report (PHR) regardless of the number of separate power control algorithms utilized, the single PHR generated based on a comparison of a current uplink transmit power to a threshold value.

For certain aspects, the two separate power control algorithms may be used for adjusting transmission power of uplink transmissions on two or more uplink channels (e.g., PUSCH, PUCCH and/or SRS).

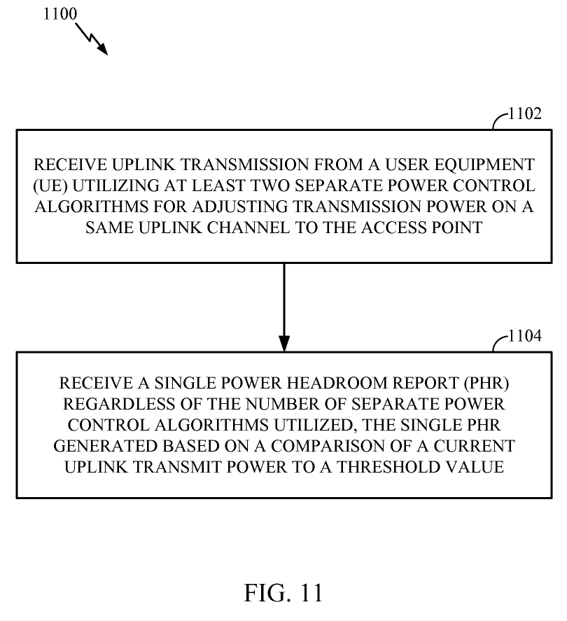

FIG. 11 illustrates example operations 1100 for uplink power control performed at an access point (e.g., a base station, eNB), in accordance with certain aspects of the disclosure. These operations may be executed, for example at processor(s) shown in FIG. 3 of eNB 110. More generally, these operations described above may be performed by any suitable components or other means capable of performing the corresponding functions. At 1102, the access point may receive uplink transmission from a user equipment (UE) utilizing at least two separate power control algorithms for adjusting transmission power on a same uplink channel to the access point. At 1104, the access point may receive a single power headroom report (PHR) regardless of the number of separate power control algorithms utilized, the single PHR generated based on a comparison of a current uplink transmit power to a threshold value.

For certain aspects, two or more power headroom reports may be used when there is at least one uplink channel with two or more power control sets. This may be preferable if the relationship among the two or more power control sets of the same uplink channel is not deterministic. Therefore, the eNB may not be able to figure out the power conditions under all power control sets for the uplink channel from a single PHR report.

For certain aspects, number of power headroom reports may depend on the number of uplink channels under two or more power control sets, and the number of power control sets for each uplink channel. In addition, similar to the single PHR case, signaling may be done implicitly or explicitly.

For example, in the case of two power control sets for PUSCH, and one set for PUCCH, the first PHR may be based on the first power control set for PUSCH and/or the power control set for PUCCH. And, the second PHR may be based on the second power control set for PUSCH and/or the power control set for PUCCH.

An additional example is the case of two power control sets for PUSCH, and two sets for PUCCH. In this case, the first PHR may be based on the first power control set for PUSCH and/or the first power control set for PUCCH. The second PHR message may be based on the second power control set for PUSCH and/or the second power control set for PUCCH that may be tied by the same virtual cell ID.

For certain aspects, in an extreme case, the number of power headroom reports may be the same as the number of combinations of power control sets over all UL channels. For example, UL channels may include PUCCH and PUSCH. Alternatively, UL channels may include SRS. The PHRs may have similar or different types. For example, A first power headroom report may have both type-1 and type-2 PHRs, while another report may only have type-1 PHR.

For certain aspects, triggering condition for transmission of each power headroom report (e.g., periodic/event driven) can be defined either separately or jointly. For certain aspects, dynamic PHR triggering may also be possible (e.g., by some information field in downlink control information (DCI) message).

For certain aspects, a PHR may not be necessary for some power control sets. As an example, PUSCH may be based on power control set f(i), PUCCH may be based on power control set g(i), and SRS may be based on two power control sets—f(i) and h(i). For instance, the first power control set (e.g., f(i)) may be used for SRS UL operation, while the second set (e.g., h(i)) may be for downlink CoMP set management. In this example, PHR for SRS based on h(i) may not be needed.

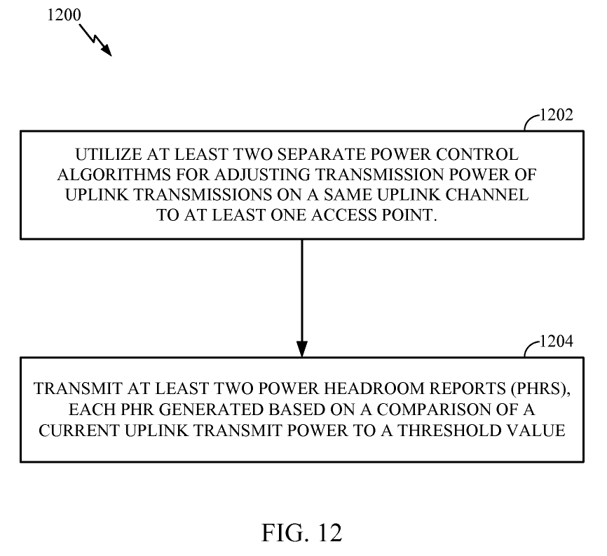

FIG. 12 illustrates example operations 1200 for uplink power control, which may be performed by a user equipment, in accordance with certain aspects of the disclosure.

At 1202, the UE may utilize at least two separate power control algorithms for adjusting transmission power of uplink transmissions on a same uplink channel to at least one access point. For certain aspects, the uplink channel to the at least one access point may be on a single component carrier. For certain aspects, a relationship between the at least two separate power control algorithms may be non-deterministic, such that an access point may not readily determine power conditions corresponding to all of the at least two separate power control algorithms from a single PHR.

At 1204, the UE transmits at least two power headroom reports (PHRs), each PHR generated based on a comparison of a current uplink transmit power to a threshold value. For certain aspects, the two separate power control algorithms may also be used for adjusting transmission power of uplink transmissions on two or more uplink channels. For certain aspects, the number of PHRs transmitted depends on a number of uplink channels for which at least two separate power control algorithms are utilized. The number of PHRs transmitted may also depend on a number of separate power control algorithms utilized for each uplink channel.

For certain aspects, the UE may also determine a virtual cell ID utilized by each of the separate power control algorithm for each of the at least one uplink channel and determine an association of each of the separate power control algorithm for each of the at least one uplink channel with one of the at least two PHRs based on at least the virtual cell ID.

For certain aspects, transmission of each of the PHRs may be based on separate semi-static configurations. For another aspect, transmission of the two PHRs is based on a single semi-static configuration. Transmission of each of the PHRs may also be triggered by an event.

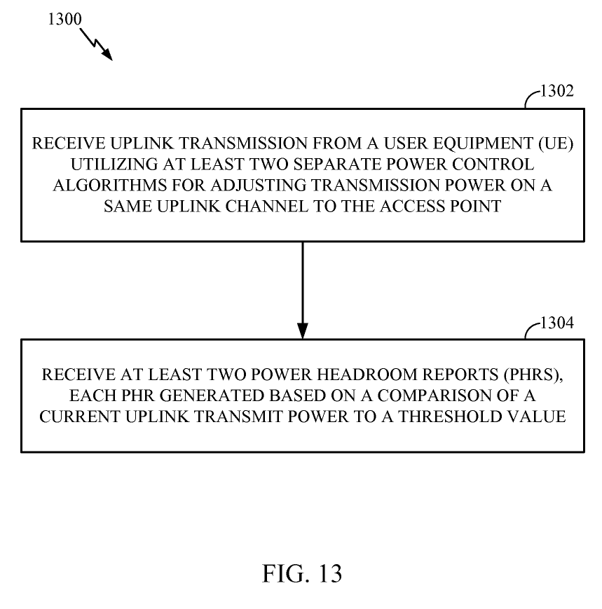

FIG. 13 illustrates example operations 1300 for uplink power control performed at an access point (e.g., a base station, eNB), in accordance with certain aspects of the disclosure. At 1302, the access point may receive uplink transmission from a user equipment (UE) utilizing at least two separate power control algorithms for adjusting transmission power on a same uplink channel to the access point. At 1304, the access point may receive at least two power headroom reports (PHRs), each PHR generated based on a comparison of a current uplink transmit power to a threshold value.

### Example Power Control Mismatch Handling

In some cases, the use of different power control sets may lead to a mismatch in uplink power control. The mismatch may be due to different reference signals (RSs) used for controlling power of different uplink channels. For example, in a system, CSI-RS may be used for pathloss estimation for SRS power control. In addition, CRS may be used for pathloss estimation for PUSCH and PUCCH power control in the same system. If SRS and PUSCH are still connected by the same f(i), and SRS is still used for operations such as UL rate prediction and UL power control, such mismatch could lead to issues such as less than optimal UL rate prediction and the like.

For certain aspects, different power control accumulative loops may be used for PUSCH and SRS. This may occur in such a way that PUSCH and SRS do not share the same f(i). For example, a PUSCH may be associated with f(i), and a SRS may be associated with h(i) for a UE. Generally, for such mismatched cases, there could be issues, especially concerning achieving the intended purpose of the UL channels. For instance, sharing the same f(i) for PUSCH and SRS is necessary for UL rate prediction.

Generally, it may be desirable for the uplink channels that are strongly related to each other to still maintain a matched power control at least for some transmissions, even though they may have mismatched power control for some other transmissions (e.g., which can be used for a different purpose). For certain aspects, if CSI-RS is used for SRS, and CRS is used for PUSCH/PUCCH, it may be desirable to maintain another CRS-based SRS power control, such that for UL rate prediction, the same RS can be used for PUSCH/PUCCH and SRS. In other words, two or more RS types may be defined for power control of one or more UL channels. Under each RS type, the power control of the uplink channels may bear some relationship, while across different RS types, the power control of uplink channels may be for different purposes and may be loosely connected.

For certain aspects, when two (or more) accumulative power control loops are specified for SRS (e.g., f(i) and h(i))—with one loop for UL and the other loop for DL, usage of the two loops may depend on the UL conditions. For example, if there is a PUSCH transmission, SRS power control may be based on f(i) such that PUSCH and SRS power control is still tightly tied together, which may be necessary for UL rate adaptation. In other situations, SRS power control may be based on g(i). The usage of power control loops may also be tied with some inactivity timer and/or discontinuous reception (DRX) procedure. As a result, a transition between f(i) and g(i) may not be immediate; but instead, the transition may occur after some amount of time.

For certain aspects, the usage of f(i) or g(i) can be based on one or more PUSCH transmissions. For example, f(i) can be used at or after one PUSCH transmission for a plurality of subsequent SRS transmissions. It should be noted that there is a difference between the proposed usage of power control loops based on UL operating conditions and managing usage of f(i) and g(i) for SRS power control via RRC configuration. The proposed arrangement may be considered more dynamic in nature. Furthermore, for certain aspects, the proposed arrangement may be signaled by one or more bits in downlink control information (DCI) to indicate whether f(i) or g(i) is to be used.

The techniques described herein may also be applied to power control sets in open loop power control. For example, two SRS power control sets may be present, one based on CRS for pathloss measurement and the other based on CSI-RS. Two SRS power control sets may also be present for different power offsets, etc. The first set may be used if there is a PUSCH. In other scenarios, the second set may be used.

For certain aspects, because aperiodic SRS may trigger a PUSCH transmission, a UE may be configured to always rely on one particular power control set (e.g., f(i)). Alternatively, the radio resource control (RRC) layer may indicate to a UE which power control set is to be used for a periodic SRS. In another aspect, the DCI may dynamically indicate which power control set to use.

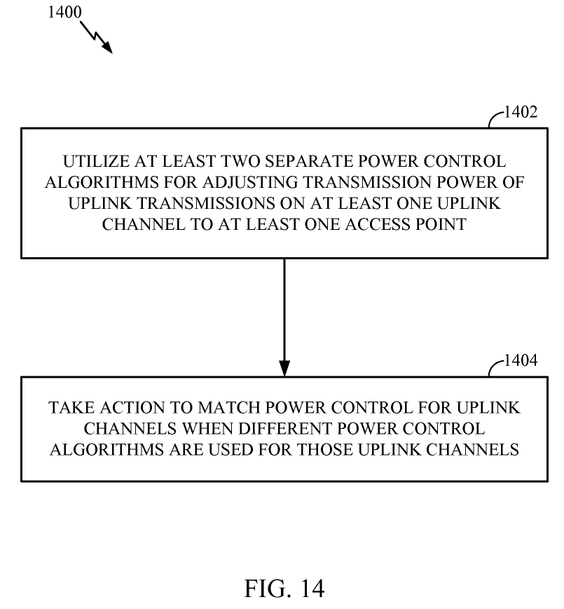

FIG. 14 illustrates example operations 1400 for uplink power control performed at a user equipment, in accordance with certain aspects of the disclosure. At 1402, the UE may utilize at least two separate power control algorithms for adjusting transmission power of uplink transmissions on a same uplink channel to at least one access point. For certain aspects, the separate power control algorithms for two uplink channels may utilize different accumulative power control functions and/or different reference signals (RSs) at least some of the time.

At 1404, the UE may take action to match power control for uplink channels when different power control algorithms are used for those uplink channels. For certain aspects, taking action may include performing transmit power control for at least some transmissions for the uplink channels based on common reference signals. For example, a same power control algorithm may be used for both of the two channels when based on a same type of RS, and different power control algorithms are used for the two channels when based on different types of RS.

For certain aspects, taking action may include utilizing a first power control algorithm for a first uplink channel for a first predetermined amount of time (e.g., based on a timer) and utilizing a second power control algorithm for the first uplink channel for a second predetermined amount of time. For certain aspects, usage of different power control algorithms may be based on uplink operation conditions. In addition, the first and second predetermined amounts of time may be based on signaling. As an example, the signaling may be conveyed in one or more downlink control information (DCI) bits.

For certain aspects, taking action may include applying a first power control algorithm for an uplink transmission in a subframe if there is a physical uplink shared channel (PUSCH) transmission in the subframe, and applying a second power control algorithm for an uplink transmission in a subframe if there is not a PUSCH transmission in the subframe.

### Example RS Switch Handling

In some cases, the locations or types of RS relied upon for power control may be dynamically defined and/or switched. Techniques presented herein may address the case of UL power control based on CSI-RS if CSI-RS switches, as well as the case of switching between CRS and CSI-RS. The switching may be semi-static, dynamic or a combination of the two. Furthermore, semi-static switching may be conducted via RRC configuration. For example, a UE may be re-configured with a new CSI-RS set for UL power control. As an additional example, a UE may be pointed to a new CSI-RS within the present set, with the new CSI-RS being used for UL power control. Yet another example is that a UE may be directed to use CRS is for UL power control, instead of a CSI-RS that was previously used.

Dynamic switching may be conducted via PDCCH. An example of this type of dynamic switching is the case in which a UE is configured with two or more CSI-RS sets for UL power control, and a PDCCH indicates which sets to use. An additional example is the case in which a UE is told whether CRS or CSI-RS should be used for UL power control.

The present disclosure presents methods to deal with switching of RS or switching between CSI-RS and CRS. For certain aspects, f(i) may be maintained even after switching. This method may be especially preferable for dynamic switching, and may be acceptable for semi-static switching as well.

For certain aspects, f(i) may be reset to zero after switching. This method may be appropriate for semi-static switching. For another aspect, f(i) may be adjusted based on the new CSI-RS/CRS, as follows:

f_{new}(i)=f_{old}(i)+PL_{new}−PL_{old}

where PL_{new} and PL_{old} represent, respectively, the estimated pathloss after and before the switching during subframe i. In addition, f_{old}(i) represents previous accumulative power control commands, and f_{new}(i) represents adjusted accumulative power control commands. This method may be appropriate for both dynamic and/or semi-static switching.

In accordance with each of the above methods for power control that is robust to RS switching, a UE may be informed via signaling of the alternative to be used when a switch occurs. An eNB may also signal an offset for f(i) adjustment to the UE. The signaled offset may coexist with any of the above methods, or may be considered separately.

The techniques presented herein to perform power control upon RS switching may also be applicable to other accumulative power control loops, such as g(i).

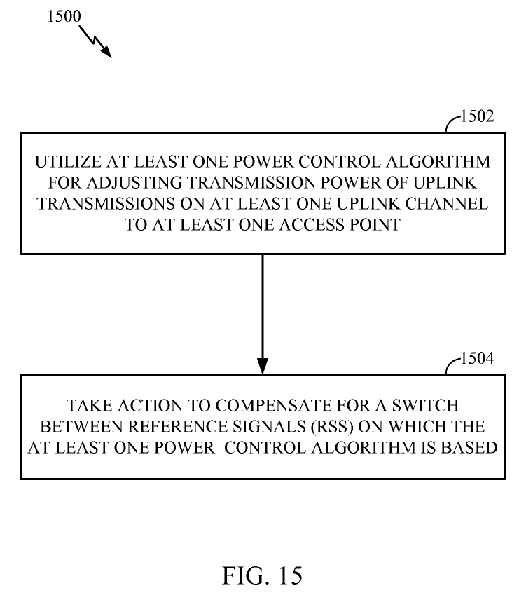

FIG. 15 illustrates example operations 1500 performed at a user equipment for power control, in accordance with certain aspects of the disclosure. At 1502, the UE may utilize at least one power control algorithm for adjusting transmission power of uplink transmissions on at least one uplink channel to at least one access point. At 1504, the UE may take action to compensate for a switch between reference signals (RSs) on which the at least one power control algorithm is based.

For example, the action may be taken to compensate for a switch between different types of RS. For certain aspects, the switch is signaled to the UE (e.g., via a PDCCH). For certain aspects, the action may include resetting an accumulative power control function to a know value. For another aspect, the action may include maintaining an accumulative power control function at a previous value. For yet another aspect, the action may include adjusting an accumulative power control function based on an estimated change in pathloss due to the switching and/or an offset value.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for receiving may be a receiver such as the antennas 332a through 332t and/or 352a through 352r as illustrated in FIG. 3. In addition, means for transmitting may be a transmitter such as the antennas 332a through 332t and/or 352a through 352r as illustrated in FIG. 3. Moreover, means for utilizing and/or means for taking action may be any processing element such as the processor 340 and/or 380 as illustrated in FIG. 3.

In addition, circuitry configured to perform a function (e.g., select, identify, determine, etc.) may be any combination of processing elements or logic circuits, such as general purpose and/or special purpose processors, and the like.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a UE 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM, or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for wireless communications by a user equipment (UE), comprising:
utilizing at least two separate power control algorithms for adjusting transmission power of uplink transmissions on a same uplink channel to at least one access point; and
transmitting a single power headroom report (PHR) regardless of the number of separate power control algorithms utilized, the single PHR generated based on a comparison of a current uplink transmit power to a threshold value.

2. The method of claim 1, wherein the uplink channel to the at least one access point is on a single component carrier.

3. The method of claim 1, wherein the two separate power control algorithms are used for adjusting transmission power of uplink transmissions on two or more uplink channels.

4. The method of claim 1, wherein the at least one access point is part of a set of access points involved in coordinated multipoint (CoMP) operations with the UE.

5. The method of claim 1, wherein a relationship between the at least two separate power control algorithms is deterministic, such that an access point may determine power conditions corresponding to the at least two separate power control algorithms from the single PHR.

6. The method of claim 5, wherein the at least two separate power control algorithms comprise:
at least two power control algorithms for a physical uplink shared channel (PUSCH); and
at least one power control algorithm for a physical uplink control channel.

7. The method of claim 1, wherein the single PHR is generated based on a first power control algorithm of the at least two power control algorithms.

8. The method of claim 1, wherein the transmission of the single PHR is based on a semi-static configuration

9. The method of claim 1, wherein the transmission of the single PHR is event-trigger based.

10. The method of claim 1, wherein the single PHR is generated as one of at least two types, the at least two types comprising a first type based on a physical uplink shared channel (PUSCH) only, and a second type based on a PUSCH and a physical uplink control channel (PUCCH).

11. A method for wireless communications by an access point, comprising:
receiving uplink transmission from a user equipment (UE) utilizing at least two separate power control algorithms for adjusting transmission power on a same uplink channel to the access point; and
receiving a single power headroom report (PHR) regardless of the number of separate power control algorithms utilized, the single PHR generated based on a comparison of a current uplink transmit power to a threshold value.

12. The method of claim 11, wherein the uplink channel to the at least one access point is on a single component carrier.

13. The method of claim 11, wherein the two separate power control algorithms are used for adjusting transmission power of uplink transmissions on two or more uplink channels.

14. The method of claim 11, wherein a relationship between the at least two separate power control algorithms is deterministic, such that the access point may determine power conditions corresponding to the at least two separate power control algorithms from the single PHR.

15. The method of claim 11, wherein the single PHR is generated based on a first power control algorithm of the at least two power control algorithms.

16. The method of claim 11, wherein the single PHR is generated by the UE as one of at least two types, the at least two types comprising a first type based on a physical uplink shared channel (PUSCH) only, and a second type based on a PUSCH and a physical uplink control channel (PUCCH).

17. A method for wireless communications by a user equipment (UE), comprising:
utilizing at least two separate power control algorithms for adjusting transmission power of uplink transmissions on a same uplink channel to at least one access point; and
transmitting at least two power headroom reports (PHRs), each PHR generated based on a comparison of a current uplink transmit power to a threshold value.

18. The method of claim 17, wherein the uplink channel to the at least one access point is on a single component carrier.

19. The method of claim 17, wherein the two separate power control algorithms are used for adjusting transmission power of uplink transmissions on two or more uplink channels.

20. The method of claim 17, wherein a relationship between the at least two separate power control algorithms is non-deterministic, such that an access point may not readily determine power conditions corresponding to all of the at least two separate power control algorithms from a single PHR.

21. The method of claim 17, wherein the number of PHRs transmitted depends on a number of uplink channels for which at least two separate power control algorithms are utilized.

22. The method of claim 17, wherein:
at least two power control algorithms are used for a physical uplink shared channel (PUSCH);
a first PHR is generated based, at least in part, on a first power control algorithm used for the PUSCH; and
a second PHR is generated based, at least in part, on a second power control algorithm for the PUSCH.

23. The method of claim 17, wherein:
at least two power control algorithms are used for a physical uplink shared channel (PUSCH);
at least two power control algorithms are used for a physical uplink control channel (PUCCH);
a first PHR is generated based on at least one of a first power control algorithm used for the PUSCH or a first power control algorithm used for the PUCCH; and
a second PHR is generated based on at least one of a first power control algorithm used for the PUSCH or a second power control algorithm used for the PUCCH.

24. The method of claim 17, further comprising:
determining a virtual cell ID utilized by each of the separate power control algorithm for each of the at least one uplink channel; and
determining an association of each of the separate power control algorithm for each of the at least one uplink channel with one of the at least two PHRs based on at least the virtual cell ID.

25. A method for wireless communications by an access point, comprising:
receiving uplink transmission from a user equipment (UE) utilizing at least two separate power control algorithms for adjusting transmission power on a same uplink channel to the access point; and
receiving at least two power headroom reports (PHRs), each PHR generated based on a comparison of a current uplink transmit power to a threshold value.

26. The method of claim 25, wherein the uplink channel to the at least one access point is on a single component carrier.

27. The method of claim 25, wherein the two separate power control algorithms are used for adjusting transmission power of uplink transmissions on two or more uplink channels.

28. The method of claim 25, wherein a relationship between the at least two separate power control algorithms is non-deterministic, such that the access point may not readily determine power conditions corresponding to all of the at least two separate power control algorithms from a single PHR.

29. The method of claim 25, wherein the number of PHRs transmitted by the UE depends on a number of uplink channels for which at least two separate power control algorithms are utilized.

30. The method of claim 25, wherein:
at least two power control algorithms are used by the UE for a physical uplink shared channel (PUSCH);
a first PHR is generated based, at least in part, on a first power control algorithm used by the UE for the PUSCH; and
a second PHR is generated based, at least in part, on a second power control algorithm used by the UE for the PUSCH.

31. The method of claim 25, wherein:
at least two power control algorithms are used by the UE for a physical uplink shared channel (PUSCH);
at least two power control algorithms are used by the UE for a physical uplink control channel (PUCCH);
a first PHR is generated based on at least one of a first power control algorithm used by the UE for the PUSCH or a first power control algorithm used for the PUCCH; and
a second PHR is generated based on at least one of a first power control algorithm used by the UE for the PUSCH or a second power control algorithm used for the PUCCH.

32. The method of claim 25, wherein:
the at least two PHRs are generated based on an association of each of the separate power control algorithms for each of the at least one uplink channel with one of the at least two PHRs based on a virtual cell ID.

33. The method of claim 25, wherein the transmission of each of the PHR by the UE is based on separate semi-static configurations.

34. A method for wireless communications by a user equipment (UE), comprising:
utilizing at least two separate power control algorithms for adjusting transmission power of uplink transmissions on at least one uplink channel to at least one access point; and
taking action to match power control for uplink channels when different power control algorithms are used for those uplink channels.

35. The method of claim 34, where the at least one access point is part of a set of access points involved in coordinated multipoint (CoMP) operations with the UE.

36. The method of claim 34, wherein the separate power control algorithms for two uplink channels utilize different reference signals (RSs) at least some of the time.

37. The method of claim 36, wherein taking action comprises basing transmit power control for at least some transmissions for the uplink channels on common reference signals.

38. The method of claim 34, wherein the separate power control algorithms for two uplink channels utilize different accumulative power control functions at least some of the time.

39. The method of claim 34, wherein taking action comprises:
utilizing a first power control algorithm for a first uplink channel for a first predetermined amount of time; and
utilizing a second power control algorithm for the first uplink channel for a second predetermined amount of time.

40. The method of claim 39, wherein utilizing different power control algorithms is based on uplink operation conditions.

41. The method of claim 39, wherein the first and second predetermined amounts of time are based on signaling.

42. The method of claim 34, wherein taking action comprises:
applying a first power control algorithm for an uplink transmission in a subframe if there is a physical uplink shared channel (PUSCH) transmission in the subframe; and
applying a second power control algorithm for the uplink transmission in the subframe if there is not any PUSCH transmission in the subframe.

43. A method for wireless communications by a user equipment (UE), comprising:
utilizing at least one power control algorithm for adjusting transmission power of uplink transmissions on at least one uplink channel to at least one access point; and
taking action to compensate for a switch between reference signals (RSs) on which the at least one power control algorithm is based.

44. The method of claim 43, wherein the action is taken to compensate for the switch between RS of the same type, but transmitted from different cells.

45. The method of claim 43, wherein the switch is signaled to the UE.

46. The method of claim 43, wherein the action comprises resetting an accumulative power control function to a known value.

47. The method of claim 43, wherein the action comprises adjusting an accumulative power control function based on an estimated change in pathloss due to the switching.

48. An apparatus for wireless communications by a user equipment (UE), comprising:
means for utilizing at least two separate power control algorithms for adjusting transmission power of uplink transmissions on a same uplink channel to at least one access point; and
means for transmitting a single power headroom report (PHR) regardless of the number of separate power control algorithms utilized, the single PHR generated based on a comparison of a current uplink transmit power to a threshold value.

49. The apparatus of claim 48, wherein the uplink channel to the at least one access point is on a single component carrier.

50. The apparatus of claim 48, wherein the two separate power control algorithms are used for adjusting transmission power of uplink transmissions on two or more uplink channels.

51. The apparatus of claim 48, wherein the at least one access point is part of a set of access points involved in coordinated multipoint (CoMP) operations with the UE.

52. The apparatus of claim 48, wherein a relationship between the at least two separate power control algorithms is deterministic, such that an access point may determine power conditions corresponding to the at least two separate power control algorithms from the single PHR.

53. The apparatus of claim 52, wherein the at least two separate power control algorithms comprise:
at least two power control algorithms for a physical uplink shared channel (PUSCH); and
at least one power control algorithm for a physical uplink control channel.

54. The apparatus of claim 48, wherein the single PHR is generated based on a first power control algorithm of the at least two power control algorithms.

55. The apparatus of claim 48, wherein the transmission of the single PHR is based on a semi-static configuration

56. The apparatus of claim 48, wherein the transmission of the single PHR is event-trigger based.

57. The apparatus of claim 48, wherein the single PHR is generated as one of at least two types, the at least two types comprising a first type based on a physical uplink shared channel (PUSCH) only, and a second type based on a PUSCH and a physical uplink control channel (PUCCH).

58. An apparatus for wireless communications by an access point, comprising:
means for receiving uplink transmission from a user equipment (UE) utilizing at least two separate power control algorithms for adjusting transmission power on a same uplink channel to the access point; and
means for receiving a single power headroom report (PHR) regardless of the number of separate power control algorithms utilized, the single PHR generated based on a comparison of a current uplink transmit power to a threshold value.

59. The apparatus of claim 58, wherein the uplink channel to the at least one access point is on a single component carrier.

60. The apparatus of claim 58, wherein the two separate power control algorithms are used for adjusting transmission power of uplink transmissions on two or more uplink channels.

61. The apparatus of claim 58, wherein a relationship between the at least two separate power control algorithms is deterministic, such that the access point may determine power conditions corresponding to the at least two separate power control algorithms from the single PHR.

62. The apparatus of claim 58, wherein the single PHR is generated based on a first power control algorithm of the at least two power control algorithms.

63. The apparatus of claim 58, wherein the single PHR is generated by the UE as one of at least two types, the at least two types comprising a first type based on a physical uplink shared channel (PUSCH) only, and a second type based on a PUSCH and a physical uplink control channel (PUCCH).

64. An apparatus for wireless communications by a user equipment (UE), comprising:
means for utilizing at least two separate power control algorithms for adjusting transmission power of uplink transmissions on a same uplink channel to at least one access point; and
means for transmitting at least two power headroom reports (PHRs), each PHR generated based on a comparison of a current uplink transmit power to a threshold value.

65. The apparatus of claim 64, wherein the uplink channel to the at least one access point is on a single component carrier.

66. The apparatus of claim 64, wherein the two separate power control algorithms are used for adjusting transmission power of uplink transmissions on two or more uplink channels.

67. The apparatus of claim 64, wherein a relationship between the at least two separate power control algorithms is non-deterministic, such that an access point may not readily determine power conditions corresponding to all of the at least two separate power control algorithms from a single PHR.

68. The apparatus of claim 64, wherein the number of PHRs transmitted depends on a number of uplink channels for which at least two separate power control algorithms are utilized.

69. The apparatus of claim 64, wherein:
at least two power control algorithms are used for a physical uplink shared channel (PUSCH);
a first PHR is generated based, at least in part, on a first power control algorithm used for the PUSCH; and
a second PHR is generated based, at least in part, on a second power control algorithm for the PUSCH.

70. The apparatus of claim 64, wherein:
at least two power control algorithms are used for a physical uplink shared channel (PUSCH);
at least two power control algorithms are used for a physical uplink control channel (PUCCH);
a first PHR is generated based on at least one of a first power control algorithm used for the PUSCH or a first power control algorithm used for the PUCCH; and
a second PHR is generated based on at least one of a first power control algorithm used for the PUSCH or a second power control algorithm used for the PUCCH.

71. The apparatus of claim 64, further comprising:
means for determining a virtual cell ID utilized by each of the separate power control algorithm for each of the at least one uplink channel; and
means for determining an association of each of the separate power control algorithm for each of the at least one uplink channel with one of the at least two PHRs based on at least the virtual cell ID.

72. An apparatus for wireless communications by an access point, comprising:
means for receiving uplink transmission from a user equipment (UE) utilizing at least two separate power control algorithms for adjusting transmission power on a same uplink channel to the access point; and
means for receiving at least two power headroom reports (PHRs), each PHR generated based on a comparison of a current uplink transmit power to a threshold value.

73. The apparatus of claim 72, wherein the uplink channel to the at least one access point is on a single component carrier.

74. The apparatus of claim 72, wherein the two separate power control algorithms are used for adjusting transmission power of uplink transmissions on two or more uplink channels.

75. The apparatus of claim 72, wherein a relationship between the at least two separate power control algorithms is non-deterministic, such that the access point may not readily determine power conditions corresponding to all of the at least two separate power control algorithms from a single PHR.

76. The apparatus of claim 72, wherein the number of PHRs transmitted by the UE depends on a number of uplink channels for which at least two separate power control algorithms are utilized.

77. The apparatus of claim 72, wherein:
at least two power control algorithms are used by the UE for a physical uplink shared channel (PUSCH);
a first PHR is generated based, at least in part, on a first power control algorithm used by the UE for the PUSCH; and
a second PHR is generated based, at least in part, on a second power control algorithm used by the UE for the PUSCH.

78. The apparatus of claim 72, wherein:
at least two power control algorithms are used by the UE for a physical uplink shared channel (PUSCH);
at least two power control algorithms are used by the UE for a physical uplink control channel (PUCCH);
a first PHR is generated based on at least one of a first power control algorithm used by the UE for the PUSCH or a first power control algorithm used for the PUCCH; and
a second PHR is generated based on at least one of a first power control algorithm used by the UE for the PUSCH or a second power control algorithm used for the PUCCH.

79. The apparatus of claim 72, wherein:
the at least two PHRs are generated based on an association of each of the separate power control algorithms for each of the at least one uplink channel with one of the at least two PHRs based on a virtual cell ID.

80. The apparatus of claim 72, wherein the transmission of each of the PHR by the UE is based on separate semi-static configurations.

81. An apparatus for wireless communications by a user equipment (UE), comprising:
means for utilizing at least two separate power control algorithms for adjusting transmission power of uplink transmissions on at least one uplink channel to at least one access point; and
means for taking action to match power control for uplink channels when different power control algorithms are used for those uplink channels.

82. The apparatus of claim 81, where the at least one access point is part of a set of access points involved in coordinated multipoint (CoMP) operations with the UE.

83. The apparatus of claim 81, wherein the separate power control algorithms for two uplink channels utilize different reference signals (RSs) at least some of the time.

84. The apparatus of claim 83, wherein the means for taking action comprises means for basing transmit power control for at least some transmissions for the uplink channels on common reference signals.

85. The apparatus of claim 81, wherein the separate power control algorithms for two uplink channels utilize different accumulative power control functions at least some of the time.

86. The apparatus of claim 81, wherein the means for taking action comprises:
means for utilizing a first power control algorithm for a first uplink channel for a first predetermined amount of time; and
means for utilizing a second power control algorithm for the first uplink channel for a second predetermined amount of time.

87. The apparatus of claim 86, wherein different power control algorithms are utilized based on uplink operation conditions.

88. The apparatus of claim 86, wherein the first and second predetermined amounts of time are based on signaling.

89. The apparatus of claim 81, wherein the means for taking action comprises:
means for applying a first power control algorithm for an uplink transmission in a subframe if there is a physical uplink shared channel (PUSCH) transmission in the subframe; and
means for applying a second power control algorithm for the uplink transmission in the subframe if there is not any PUSCH transmission in the subframe.

90. An apparatus for wireless communications by a user equipment (UE), comprising:
means for utilizing at least one power control algorithm for adjusting transmission power of uplink transmissions on at least one uplink channel to at least one access point; and
means for taking action to compensate for a switch between reference signals (RSs) on which the at least one power control algorithm is based.

91. The apparatus of claim 90, wherein the action is taken to compensate for the switch between RS of the same type, but transmitted from different cells.

92. The apparatus of claim 90, wherein the switch is signaled to the UE.

93. The apparatus of claim 90, wherein the action comprises resetting an accumulative power control function to a known value.

94. The apparatus of claim 90, wherein the action comprises adjusting an accumulative power control function based on an estimated change in path-loss due to the switching.

95. An apparatus for wireless communications by a user equipment (UE), comprising at least one processor configured to:
utilize at least two separate power control algorithms for adjusting transmission power of uplink transmissions on a same uplink channel to at least one access point, and
transmit a single power headroom report (PHR) regardless of the number of separate power control algorithms utilized, the single PHR generated based on a comparison of a current uplink transmit power to a threshold value; and
a memory coupled to the at least one processor.

96. An apparatus for wireless communications by an access point, comprising at least one processor configured to:
receive uplink transmission from a user equipment (UE) utilizing at least two separate power control algorithms for adjusting transmission power on a same uplink channel to the access point, and
receive a single power headroom report (PHR) regardless of the number of separate power control algorithms utilized, the single PHR generated based on a comparison of a current uplink transmit power to a threshold value; and
a memory coupled to the at least one processor.

97. An apparatus for wireless communications by a user equipment (UE), comprising at least one processor configured to:
utilize at least two separate power control algorithms for adjusting transmission power of uplink transmissions on a same uplink channel to at least one access point, and
transmit at least two power headroom reports (PHRs), each PHR generated based on a comparison of a current uplink transmit power to a threshold value; and
a memory coupled to the at least one processor.

98. An apparatus for wireless communications by an access point, comprising at least one processor configured to:
receive uplink transmission from a user equipment (UE) utilizing at least two separate power control algorithms for adjusting transmission power on a same uplink channel to the access point, and
receive at least two power headroom reports (PHRs), each PHR generated based on a comparison of a current uplink transmit power to a threshold value; and
a memory coupled to the at least one processor.

99. An apparatus for wireless communications by a user equipment (UE), comprising at least one processor configured to:
utilize at least two separate power control algorithms for adjusting transmission power of uplink transmissions on at least one uplink channel to at least one access point, and
take action to match power control for uplink channels when different power control algorithms are used for those uplink channels; and
a memory coupled to the at least one processor.

100. An apparatus for wireless communications by a user equipment (UE), comprising at least one processor configured to:
utilize at least one power control algorithm for adjusting transmission power of uplink transmissions on at least one uplink channel to at least one access point, and
take action to compensate for a switch between reference signals (RSs) on which the at least one power control algorithm is based; and
a memory coupled to the at least one processor.

101. A computer-program product for wireless communications by a user equipment (UE), the computer-program product comprising a non-transitory computer readable storage medium with computer-readable instructions stored thereon, the computer-readable instructions operable for causing a processor to:
utilize at least two separate power control algorithms for adjusting transmission power of uplink transmissions on a same uplink channel to at least one access point; and
transmit a single power headroom report (PHR) regardless of the number of separate power control algorithms utilized, the single PHR generated based on a comparison of a current uplink transmit power to a threshold value.

102. A computer-program product for wireless communications by an access point, the computer-program product comprising a non-transitory computer readable storage medium with computer-readable instructions stored thereon, the computer-readable instructions operable for causing a processor to:
receive uplink transmission from a user equipment (UE) utilizing at least two separate power control algorithms for adjusting transmission power on a same uplink channel to the access point; and
receive a single power headroom report (PHR) regardless of the number of separate power control algorithms utilized, the single PHR generated based on a comparison of a current uplink transmit power to a threshold value.

103. A computer-program product for wireless communications by a user equipment (UE), the computer-program product comprising a non-transitory computer readable storage medium with computer-readable instructions stored thereon, the computer-readable instructions operable for causing a processor to:
utilize at least two separate power control algorithms for adjusting transmission power of uplink transmissions on a same uplink channel to at least one access point; and
transmit at least two power headroom reports (PHRs), each PHR generated based on a comparison of a current uplink transmit power to a threshold value.

104. A computer-program product for wireless communications by an access point, the computer-program product comprising a non-transitory computer readable storage medium with computer-readable instructions stored thereon, the computer-readable instructions operable for causing a processor to:
receive uplink transmission from a user equipment (UE) utilizing at least two separate power control algorithms for adjusting transmission power on a same uplink channel to the access point; and
receive at least two power headroom reports (PHRs), each PHR generated based on a comparison of a current uplink transmit power to a threshold value.

105. A computer-program product for wireless communications by a user equipment (UE), the computer-program product comprising a non-transitory computer readable storage medium with computer-readable instructions stored thereon, the computer-readable instructions operable for causing a processor to:
utilize at least two separate power control algorithms for adjusting transmission power of uplink transmissions on at least one uplink channel to at least one access point; and
take action to match power control for uplink channels when different power control algorithms are used for those uplink channels.

106. A computer-program product for wireless communications by a user equipment (UE), the computer-program product comprising a non-transitory computer readable storage medium with computer-readable instructions stored thereon, the computer-readable instructions operable for causing a processor to:
utilize at least one power control algorithm for adjusting transmission power of uplink transmissions on at least one uplink channel to at least one access point; and
take action to compensate for a switch between reference signals (RSs) on which the at least one power control algorithm is based.
